(19) United States
(12) Patent Application Publication
(10) Pub. No.: US 2009/0040147 A1
(43) Pub. Date: Feb. 12, 2009

(54) Plasma display and driving method thereof

(76) Inventor: Seong-Joon Jeong, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/081,971

(22) Filed: Apr. 24, 2008

(30) Foreign Application Priority Data
Aug. 9, 2007 (KR) 10-2007-0080105

(51) Int. Cl. G09G 3/28

(52) U.S. Cl. 345/63

(57) ABSTRACT

The plasma display includes a controller and a driver. The controller divides one frame into a plurality of subfields, and establishes address and sustain periods in the respective subfields according to a subfield load ratio indicating a ratio of light emitting cells in the respective subfields. The driver selects a light emitting cell among the plurality of discharge cells during the established address period and sustain-discharges the light emitting cell during the established sustain period.

### BACKGROUND OF THE INVENTION

1. Field of the Invention

Embodiments relate to a plasma display and a driving method thereof.

2. Description of the Related Art

A plasma display panel (PDP) is a flat panel display that uses plasma generated by gas discharge to display characters or images. In general, one frame of the PDP is divided into a plurality of subfields so as to drive the PDP. Turn-on/turn-off cells (i.e., cells to be turned on or off) are selected during an address period of each subfield, and a sustain discharge operation is performed on the turn-on cells so as to display an image during a sustain period. Grayscales are expressed by a combination of weights of the subfields that are used to perform a display operation.

The PDP calculates a screen load ratio from a video signal input for one frame, and calculates an automatic power control (APC) level according to the calculated screen load ratio. In addition, driving operations in the address period and the sustain period are controlled according to the calculated APC level. The APC level is proportional to brightness and a cell area that emits light in the PDP, and does not relate to discharge characteristics of each subfield. For example, the APC levels for a wide light-emitting area having a low grayscale may be the same for a wide light-emitting area having a high grayscale. Since the number of light emitting cells is reduced in a wide light-emitting area having a low grayscale, a discharge delay may increase. In contrast, since the number of light emitting cells is increased in a wide light-emitting area having a high grayscale, a discharge delay may decrease. Accordingly, even when APC levels are the same, discharge characteristics may differ in respective subfields.

As described, when the same driving methods are used in frames having different discharge characteristics, discharge may be unstably generated due to the discharge delay and/or brightness may be reduced.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention are therefore directed to a plasma display and a driving method, which substantially overcome one or more of the problems due to the limitations and disadvantages of the related art.

It is therefore a feature of an embodiment of the present invention to provide a plasma display and a driving method for stably generating a discharge by considering discharge characteristics of a screen.

It is therefore another feature of an embodiment of the present invention to provide a plasma display and driving method for improving luminance by considering discharge characteristics of a screen.

At least one of the above and other features and advantages may be realized by providing a plasma display, including a plurality of discharge cells, a controller configured to divide one frame into a plurality of subfields, and establish at least one of an address period and a sustain period in respective subfields according to a subfield load ratio of the respective subfields, and a driver configured to select light emitting cells among the plurality of discharge cells during the established address period and to sustain-discharge the light emitting cells during the established sustain period.

The controller may include a subfield load ratio calculating unit configured to calculate the subfield load ratio from a video signal input during the frame, and a period establishing unit configured to establish the address period in each subfield in proportion to the subfield load ratio of each subfield and to establish the sustain period according to the established address period. The subfield load ratio calculating unit may be configured to calculate the subfield load ratio from a ratio of a number of all the discharge cells and a number of light emitting cells in the corresponding subfield. The controller may be configured to establish the address period in proportion to the subfield load ratio; and establish the sustain period according to the established address period

The driver may be configured to apply an address pulse to the light emitting cell during the address period, wherein a width of the address pulse in a first subfield among the plurality of subfields is shorter than a width of the address pulse in a second subfield, the subfield load ratio of the second subfield being greater than the subfield load ratio of the first subfield. The driver may be configured to apply a sustain pulse to the light emitting cell during the sustain period, wherein a width of the sustain pulse in a first subfield among the plurality of subfields is longer than a width of the sustain pulse in a second subfield the subfield load ratio of the second subfield being greater than the subfield load ratio of the first subfield.

The plurality of discharge cells may include a plurality of first discharge cells and a plurality of second discharge cells, and the controller may be configured to divide the address period into first and second address periods with respect to the plurality of first and second discharge cells, establish one sustain period to be a first sustain period between the first and second address periods, establish another sustain period to be a second sustain period after the second address period, and establish the first sustain period in proportion to the subfield load ratio

At least one subfield among the plurality of subfields may include a reset period for initializing at least one discharge cell among the plurality of discharge cells, the controller being configured to establish the address period in proportion to the subfield load ratio and at least one of the sustain period and the reset period according to the established address period.

At least one of the above and other features and advantages may be realized by providing a driving method of a plasma display including a plurality of discharge cells and one frame divided into a plurality of subfields respectively including an address period and a sustain period, the driving method including calculating a subfield load ratio of each subfield from a video signal input during the frame, establishing at least one of the address period and the sustain period in respective subfields according to the calculated subfield load ratio, selecting light emitting cells from among the plurality of discharge cells during the established address period, and sustain-discharging the light emitting cells a number of times corresponding to a weight value of the corresponding subfield during the established sustain period.

The subfield load ratio may be calculated from a ratio of a number of all the discharge cells and a number of light emitting cells in the corresponding subfield. Establishing of the at least one of the address period and the sustain period may include establishing the address period in proportion to the subfield load ratio, and establishing the sustain period according to the established address period.

At least one subfield among the plurality of subfields may include a reset period for initializing at least one discharge cell among the plurality of discharge cells, and establishing of at least one of the address period and the sustain period includes establishing the address period in proportion to the subfield load ratio, and establishing at least one of the sustain period and the reset period according to the established address period.

Selecting light emitting cells may include applying an address pulse to the light emitting cells, wherein a width of the address pulse in a first subfield among the plurality of subfields is shorter than a width of the address pulse in a second subfield, the subfield load ratio of the second subfield being greater than the subfield load ratio of the first subfield. Sustain-discharging the light emitting cells may include applying a sustain pulse to the light emitting cells, wherein a width of the sustain pulse in a first subfield among the plurality of subfields is longer than a width of the sustain pulse in a second subfield the subfield load ratio of the second subfield being greater than the subfield load ratio of the first subfield.

At least one of the above and other features and advantages may be realized by providing a method for driving a plasma display including a plurality of discharge cells while dividing one frame into a plurality of subfields, the method including calculating a subfield load ratio of each subfield from a video signal input during the frame, determining a width of an address pulse in each subfield according to the subfield load ratio, and applying the address pulse of the determined width to light emitting cells among the plurality of discharge cells during an address period of each subfield.

Determining of the width may include establishing the width of the address pulse in a first subfield among the plurality of subfields to be shorter than that of the address pulse in a second subfield having the subfield load ratio that is greater than that of the first subfield.

The method may further include determining a width of a sustain pulse in each subfield according to the subfield load ratio, and applying the sustain pulse of the determined width to the plurality of discharge cells during a sustain period of each subfield. Determining of the width of the sustain pulse may include establishing the width of the sustain pulse in a first subfield among the plurality of subfields to be longer than that of the sustain pulse in a second subfield having the subfield load ratio that is greater than that of the first subfield.

The subfield load ratio may be calculated from a ratio of a number of all the discharge cells and a number of light emitting cells in the corresponding subfield.

At least one subfield among the plurality of subfields may include a reset period for initializing at least one discharge cell among the plurality of discharge cells, further including determining a width of a pulse in at least one of the sustain period and the reset period according to the width of the address pulse.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a schematic view of a plasma display according to an exemplary embodiment of the present invention;

FIG. 2 illustrates a diagram of a subfield arrangement according to a first exemplary embodiment of the present invention;

FIG. 3 illustrates a driving waveform of the plasma display according to the first exemplary embodiment of the present invention;

FIG. 4 illustrates a block diagram of a controller according to an exemplary embodiment of the present invention;

FIG. 5 illustrates a flowchart of an operation of the controller according to an exemplary embodiment of the present invention;

FIG. 6 illustrates a diagram of a subfield arrangement according to a second exemplary embodiment of the present invention; and

FIG. 7 illustrates a driving waveform of the plasma display according to the second exemplary embodiment of the present invention.

### DETAILED DESCRIPTION OF THE INVENTION

Korean Patent Application No. 10-2007-0080105, filed on Aug. 9, 2007, in the Korean Intellectual Property Office, and entitled: “Plasma Display and Driving Method Thereof,” is incorporated by reference herein in its entirety.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

A plasma display according to an exemplary embodiment of the present invention and a driving method thereof will now be described.

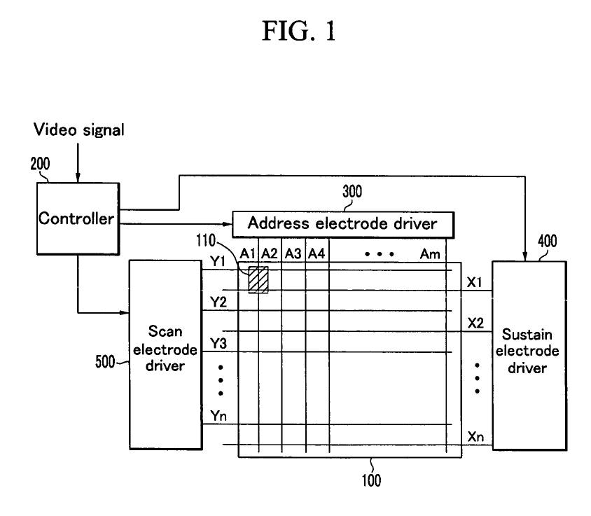

FIG. 1 illustrates a schematic view of a plasma display according to an exemplary embodiment of the present invention. As shown in FIG. 1, the plasma display according to an exemplary embodiment may include a plasma display panel (PDP) 100, a controller 200, an address electrode driver 300, a sustain electrode driver 400, and a scan electrode driver 500.

The PDP 100 may includes a plurality of address electrodes A1 to Am (hereinafter referred to as “A electrodes”) extending in a column direction, and a plurality of sustain and scan electrodes (hereinafter referred to as “X electrodes” and “Y electrodes”) X1 to Xn and Y1 to Yn extending in a row direction in pairs. In general, the X electrodes X1 to Xn may correspond to the Y electrodes Y1 to Yn, respectively. The Y electrodes Y1 to Yn and the X electrodes X1 to Xn may cross the A electrodes A1 to Am. Discharge spaces at intersections of the A electrodes A1 to Am and the X and Y electrodes X1 to Xn and Y1 to Yn form discharge cells 110.

The controller 200 may receive an external video signal, and may output an A electrode driving control signal, an X electrode driving control signal, and a Y electrode driving control signal. In addition, the controller 200 may divide one frame into a plurality of subfields. Each subfield may include a reset period, an address period, and a sustain period. Further, the controller 200 may calculate a subfield load ratio of each subfield, i.e., subfield by subfield, according to the input video signal, and establish the address period and the sustain period according to the calculated subfield load ratio.

The address electrode driver 300 may apply a display data signal to the A electrodes A1-Am according to the A electrode driving control signal received from the controller 200. The sustain electrode driver 400 may apply a driving voltage to the X electrodes X1-Xn according to the X electrode driving control signal received from the controller 200. The sustain electrode driver 500 may apply a driving voltage to the Y electrodes Y1-Yn according to the Y electrode driving control signal received from the controller 200.

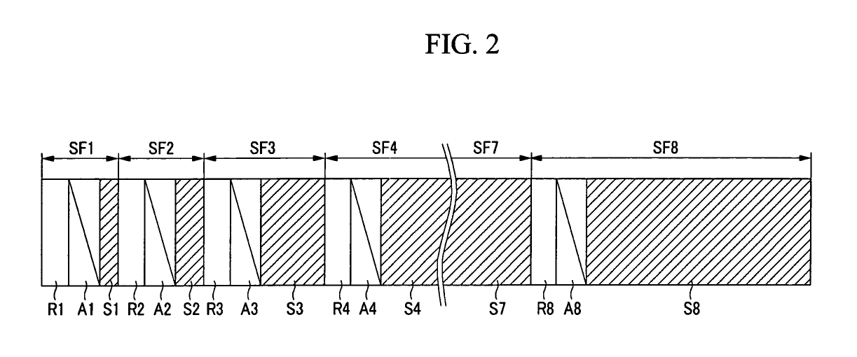

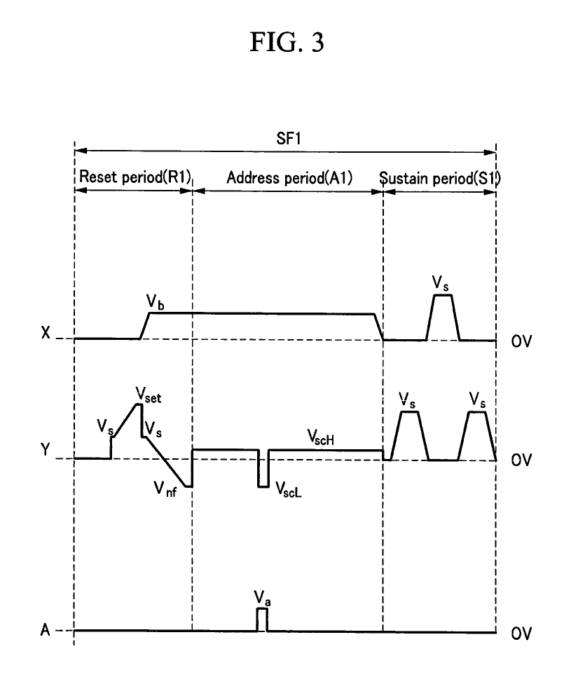

Referring to FIG. 2 and FIG. 3, a plasma display according to a first exemplary embodiment of the present invention and a driving method thereof will be now described.

FIG. 2 illustrates a subfield arrangement according to the first exemplary embodiment of the present invention, and FIG. 3 illustrates a driving waveform of the plasma display according to the first exemplary embodiment of the present invention. In FIG. 3, for better understanding and ease of description, only a first subfield SF1 among a plurality of subfields SF1 to SF8 shown in FIG. 2 is illustrated. Further, a sustain discharge is illustrated as being generated three times during the sustain period of the first subfield SF1. In addition, only one X electrode, one Y electrode, and one A electrode are illustrated.

As shown in FIG. 2, the controller 200 may divide one frame into the plurality of subfields SF1 to SF8 respectively having luminance weight values, and may allocate times in respective subfields SF1 to SF8 to reset periods R1 to R8, address periods A1 to A8, and sustain periods S1 to S8. Weight values of the respective subfields SF1 to SF8 may be determined by a number of sustain discharges in the sustain periods S1 to S8 of the corresponding subfield.

At least one discharge cell among a plurality of discharge cells may be initialized in the reset periods R1 to R8, and light emitting cells and non-light emitting cells may be selected in the address periods A1 to A8. In the sustain periods S1 to S8, light emitting cells are sustain-discharged.

To perform operations of the reset, address, and sustain periods, as shown in FIG. 3, the address electrode driver 300 and the sustain electrode driver 400 may respectively apply a reference voltage (e.g., a 0V voltage in FIG. 3) to the A electrode and the X electrode during the reset period R1, and the scan electrode driver 500 may gradually increase a voltage at the Y electrode, e.g., a Vs voltage to a Vset voltage, while the reference voltage is applied to the A and X electrodes. Subsequently, the sustain electrode driver 400 may apply a Vb voltage to the X electrode, and the scan electrode driver 500 may gradually decrease the voltage at the Y electrode, e.g., from the Vs voltage to a Vnf voltage, while the Vb voltage is applied to the X electrode. Thereby, wall charges are formed on the discharge cells since a weak reset discharge is generated between the Y electrode and the X electrode while the voltage at the Y electrode increases, the wall charges formed on the discharge cells are eliminated since the weak reset discharge is generated between the Y electrode and the X electrode while the voltage at the Y electrode decreases, and the discharge cells are initialized to be non-light emitting cells.

During the address period A1, the scan electrode driver 500 may apply a scan pulse having a VscL voltage to the Y electrode. In this case, the address electrode driver 300 may apply a Va voltage to the A electrode passing through light emitting cells among the plurality of discharge cells defined by the Y electrode to which the VscL voltage is applied, and the X electrode may be maintained at the Vb voltage. Thereby, an address discharge is generated between the Y electrode to which the VscL voltage is applied and the A electrode to which the Va voltage is applied. In the first exemplary embodiment, while a cell in which the address discharge cell is generated is selected as a light emitting cell, the present invention is not limited thereto, e.g., the cell in which the address discharge is generated may be selected as a non-light emitting cell. In addition, the scan electrode driver 500 may apply a VscH voltage, higher than the VscL voltage, to the Y electrode to which the VscL voltage is not applied, and the address electrode driver 300 may apply the reference voltage to the A electrode of the non-light emitting cells.

During the sustain period S1, the scan electrode driver 500 may apply a sustain pulse having a high level voltage (e.g., the Vs voltage in FIG. 3) and a low level voltage (e.g., the 0V voltage in FIG. 3) to the Y electrode according to a weight value of the first subfield SF1. In addition, the sustain electrode driver 400 may apply sustain pulses to the X and Y electrodes. The sustain pulse applied to the X electrode may have an opposite phase to the sustain pulse applied to the Y electrode. A voltage difference between the Y electrode and the X electrode may alternate between the Vs voltage and a −Vs voltage. The sustain discharge may thus be generated in the light emitting cell a predetermined number of times.

In addition, the same driving waveforms shown in FIG. 3 may be applied in the reset periods R2 to R8, the address periods A2 to A8, and the sustain periods S2 to S8 in the remaining subfields SF2 to SF8. However, the number of sustain pulses applied to the Y electrode and the X electrode in the sustain period may differ according to the weight value of each subfield.

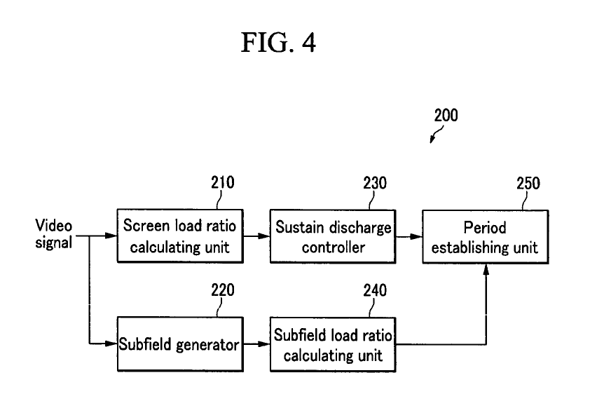

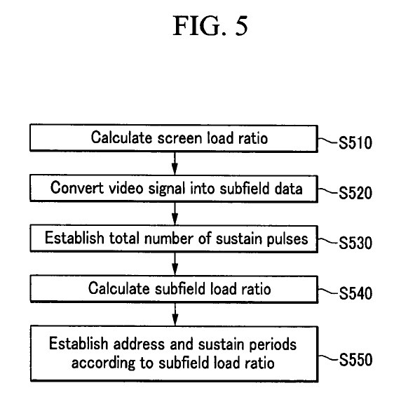

A method for establishing the address period and the sustain period according to the subfield load ratio by the controller 200 will now be described with reference to FIG. 4 and FIG. 5. FIG. 4 illustrates a block diagram of the controller 200 according to an exemplary embodiment, and FIG. 5 illustrates a flowchart of an operation of the controller 200 according to an exemplary embodiment.

As shown in FIG. 4, the controller 200 may include a screen load ratio calculating unit 210, a subfield generator 220, a sustain discharge controller 230, a subfield load ratio calculating unit 240, and a period establishing unit 250. In the controller shown in FIG. 4, parts that do not relate to descriptions of the controller 200 according to an exemplary embodiment may be omitted for clarity.

As shown in FIGS. 4 and 5, the screen load ratio calculating unit 210 may calculate a screen load ratio of a corresponding frame according to the video signal input during one frame in operation S510. For example, the screen load ratio calculating unit 210 may calculate the screen load ratio from an average signal level (ASL) of the video signal during one frame as given in Equation 1.

$$A S L = ( {\sum }_{V} {R}_{n} + {\sum }_{V} {G}_{n} + {\sum }_{V} {B}_{n} ) / 3 N \qquad [ Equation 1 ]$$

Here, Rₙ, Gₙ, and Bₙ respectively denote gray levels of R, G, and B image data, V denotes one frame, and 3N denotes a number of R, G, and B image data input during one frame.

The subfield generator 220 may convert a plurality of video signals into a plurality of subfield data in operation S520.

The sustain discharge controller 230 may establish a total number of sustain pulses allocated to one frame according to the calculated screen load ratio in operation S530. In addition, the sustain pulse of each subfield may be allocated according to the weight value of each subfield. In this case, the total number of sustain pulses may be calculated by performing a logic operation of data corresponding to the screen load ratio, and may be stored in a lookup table. That is, when the screen load ratio increases, since the number of light emitting cells increases, the total number of sustain pulses decreases. Therefore, power consumption may be prevented from being increased.

The subfield load ratio calculating unit 240 may use the converted subfield data to calculate a subfield ratio, e.g., a ratio of a number of discharge cells to a number of light emitting cells, in each subfield in operation S540.

The period establishing unit 250 may establish the address period and the sustain period of each subfield according to the calculated subfield load ratio in operation S550.

In further detail, in a subfield having a low weight value (hereinafter referred to as a “low grayscale subfield”), the discharge delay may increase, since there are fewer sustain discharges. Thus, more wall charges may be lost before an address operation is performed, i.e., during an address waiting time between a last sustain pulse of a previous sustain period and a current address operation. However, in a subfield having a high weight value (hereinafter referred to as a “high grayscale subfield”), the discharge delay may decrease, since there are more sustain discharges. Thus, fewer wall charges may be lost during the address waiting time.

Accordingly, the period establishing unit 250 may establish the address period in a subfield having a lower subfield load ratio to be shorter than the address period in a subfield having a higher subfield load ratio. Thereby, the address period in the low grayscale subfield having a higher subfield load ratio may be established to be longer than the address period in the high grayscale subfield having a lower subfield load ratio. When the address period increases, widths of the scan and address pulses in the address period may be increased. Thereby, the address discharge may be generated using increased widths of the scan and address pulses in the low grayscale subfield having a high discharge delay. Since these increased widths may increase wall charges formed on the respective electrodes by the address discharge, discharge may be stably generated.

When the address period in the high grayscale subfield having a lower subfield load ratio is shortened, the period establishing unit 250 may allocate a difference to the sustain period. That is, in the high grayscale subfield having the lower subfield load ratio, the sustain period may be established to be longer by the reduced address period. When the sustain period is increased, a width of the sustain pulse may be increased, and increased wall charges may be formed on the respective electrodes after the sustain discharge. Accordingly, a subsequent sustain discharge may be strongly generated, and the luminance may be improved. Alternatively or additionally, the period establishing unit 250 may allocate part or all of a difference of the established address period to the reset period.

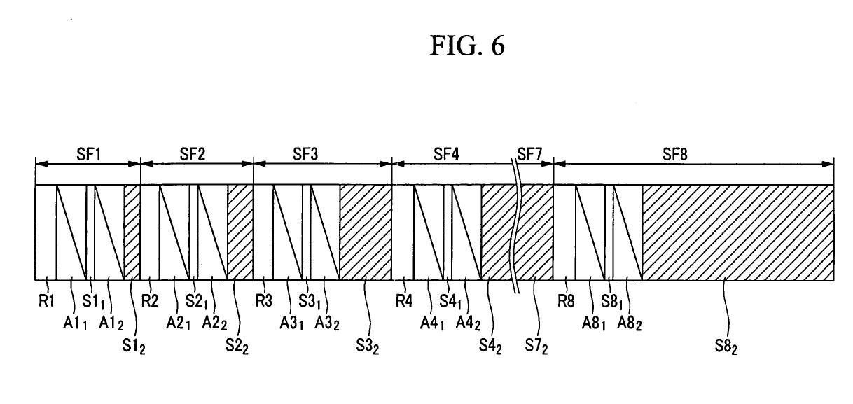

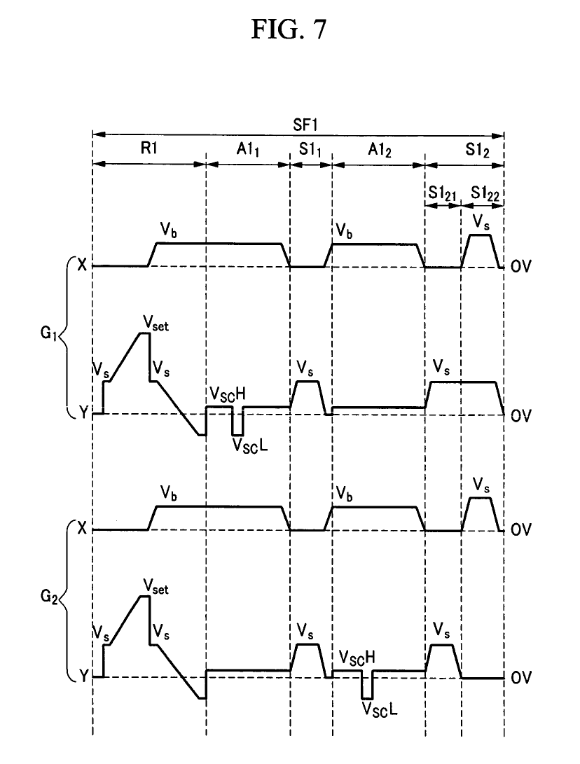

A driving method according to a second exemplary embodiment of the present invention will now be described with reference to FIG. 6 and FIG. 7.

FIG. 6 illustrates a subfield arrangement according to the second exemplary embodiment, and FIG. 7 illustrates a driving waveform of the plasma display according to the second exemplary embodiment. In FIG. 7, for better understanding and ease of description, only the first subfield among the plurality of subfields SF1 to SF8 shown in FIG. 6 is illustrated.

As shown in FIG. 6, the controller 200 may divide the plurality of X electrodes X1-Xn and the plurality of Y electrodes Y1-Yn into a plurality of groups. As illustrated in FIG. 6, the plurality of X and Y electrodes X1-Xn and Y1-Yn may be divided into a first group G₁ including a plurality of row electrodes X1-Xn/2 and Y1-Yn/2 of the PDP 100, and a second group G₂ including a plurality of row electrodes X(n/2)+1−Xn and Y(n/2)+1−Yn positioned on a lower part of the PDP 100, but the present invention is not limited thereto. For example, the row electrodes may be divided in numerous manners, e.g., into odd-numbered row electrodes and even-numbered row electrodes.

The controller 200 may establish first and second address periods A1₁-A8₁ and A1₂-A8₂ corresponding to the groups G₁ and G₂. In addition, the controller 200 may establish first sustain periods S1₁-S8₁ between the first and second address periods and second sustain periods S1₂-S8₂ after the second address periods A1₂-A8₂. A sum of lengths of the first and second sustain periods S1₁-S8₁ and S1₂-S8₂ may be the same as a length of respective sustain periods S1-S8 shown in FIG. 2, and a sum of lengths of the first and second address periods A1₁-A8₁ and A1₂-A8₂ may be the same as a length of respective address period A1-A8 shown in FIG. 2. For example, S1₁ plus S1₂ may equal S1 and A1₁ plus A1₂ may equal A1.

At least one discharge cell among the plurality of discharge cells may be initialized in the reset periods R1-R8. Discharge cells to be set as a light emitting cells among discharge cells of the first group G₁ may be discharged in the first address periods A1₁-A8₁ to form wall charges, and light emitting cells of the first group G₁ may be sustain discharged in the first sustain periods S1₁-S8₁. The first sustain periods S1₁-S8₁ may be set to generate a minimum number of sustain discharges (e.g., one or two). Subsequently, discharge cells to be set as the light emitting cells among discharge cells of the second group G₂ may be discharged in the second address periods A1₂-A8₂ to form wall charges. The light emitting cells of the second group G₂ may be sustain discharged in the second sustain periods S1₂-S8₂, while the light emitting cells of the first group G₁ may be set to not generate the sustain discharge, so that the numbers of sustain discharges of the first and second groups G₁ and G₂ may be the same.

To perform operations of the first and second address periods and the first and second sustain periods, as shown in FIG. 7, the scan electrode driver 500 may apply the scan pulse having the VscL voltage to the Y electrode of the first group G₁ while the sustain electrode driver 400 applies the Vb voltage to the X electrode of the first and second groups G₁ and G₂ in the address period Al₁. The VscH voltage may be applied to the remaining Y electrodes of the first group G₁ to which the scan pulse is not applied. While not illustrated, the address electrode driver 300 may apply the address voltage Va to the A electrode of the light emitting cells among the discharge cells formed by the Y electrode to which the VscL voltage is applied, and the reference voltage to the A electrode to which the address pulse is not applied. Subsequently, in the first sustain period S1₁, the sustain electrode driver 400 may apply the low level voltage to the X electrodes of the first and second groups G₁ and G₂, and the scan electrode driver 500 may apply the high level voltage to the Y electrodes of the first and second groups G₁ and G₂. Thereby, the sustain discharge may be generated in the light emitting cell of the first group G₁.

Subsequently, in the second address period A1₂, the scan electrode driver 500 may apply the scan pulse having the VscL voltage to the Y electrode of the second group G₂ while the sustain electrode driver 400 applies the Vb voltage to the X electrodes of the first and second groups G₁ and G₂. The VscH voltage may be applied to the remaining Y electrodes of the first group G₂ to which the scan pulse is not applied. While not illustrated, the address electrode driver 300 may apply the address voltage Va to the A electrode of the light emitting cells among the discharge cells formed by the Y electrode to which the VscL voltage is applied, and the reference voltage to the A electrode to which the address pulse is not applied. In a period S1₂₁ of the second sustain period S1₂, the sustain electrode driver 400 may apply the low level voltage to the X electrode of the first and second groups G₁ and G₂, and the scan electrode driver 500 may apply the high level voltage to the Y electrodes of the first and second groups G₁ and G₂. In a period S1₂₂ of the second sustain period S1₂, the sustain electrode driver 400 may apply the high level voltage to the X electrodes of the first and second groups G₁ and G₂, and the scan electrode driver 500 may maintain the voltage at the Y electrode of the first group G₁ at the high level voltage, so as to not generate the sustain discharge in the light emitting cell of the first group G₁, and may apply the low level voltage to the Y electrode of the second group G₂. Thereby, the sustain discharge is generated in the light emitting cells of the second group G₂. Accordingly, the number of sustain discharges in the light emitting cell of the second group G₂ in a period S1₂₂ of the second sustain period S1₂ becomes the same as the number of sustain discharges in the light emitting cell of the first group G₁ in the first sustain period S1₁.

The method for establishing the first and second address periods A1₁-A8₁ and A1₂-A8₂ and the first and second sustain periods S1₁-S8₁, and S1₂-S8₂ may be the same as that of the first exemplary embodiment of the present invention.

In addition, the controller 200 may establish the first sustain period S1₁ in proportion to the subfield load ratio of each subfield. That is, the first and second address periods and the first sustain period in the low grayscale subfield having the higher subfield load ratio may be set to be longer than the first and second address periods and the first sustain period in the high grayscale subfield having the lower subfield load ratio. When the first sustain period S1₁ is increased, the sustain discharge may be sufficiently generated in the first sustain period S1₁ even when the wall charges are lost during the addressing waiting time, and the wall charges may be sufficiently formed in the light emitting cell.

In the first and second exemplary embodiments of the present invention, the plurality of subfields may be divided into a plurality of subfield groups to establish the address and sustain periods according to the subfield load ratio. For example, the address period of the subfields in the first group may be shorter than the address period of the subfields in the second group having the subfield load ratio that is greater than that of the first group. Remainders of the address period may be allocated to the sustain period and/or the reset period. Since the address and sustain periods are established according to each subfield load ratio, a period that is unnecessarily established is reduced, and the reduced time from that period may be allocated to another period that would benefit from more time. Therefore, address discharge may be stably generated and/or luminance may be improved.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display, comprising:
a plurality of discharge cells;
a controller configured to divide one frame into a plurality of subfields, and establish at least one of an address period and a sustain period in respective subfields according to a subfield load ratio of the respective subfields; and
a driver configured to select light emitting cells among the plurality of discharge cells during the established address period and to sustain-discharge the light emitting cells during the established sustain period.

2. The plasma display as claimed in claim 1, wherein the controller comprises:
a subfield load ratio calculating unit configured to calculate the subfield load ratio from a video signal input during the frame; and
a period establishing unit configured to establish the address period in each subfield in proportion to the subfield load ratio of each subfield and to establish the sustain period according to the established address period.

3. The plasma display as claimed in claim 2, wherein the driver is configured to apply an address pulse to the light emitting cell during the address period, wherein a width of the address pulse in a first subfield among the plurality of subfields is shorter than a width of the address pulse in a second subfield, the subfield load ratio of the second subfield being greater than the subfield load ratio of the first subfield.

4. The plasma display as claimed in claim 2, wherein the driver is configured to apply a sustain pulse to the light emitting cells during the sustain period, wherein a width of the sustain pulse in a first subfield among the plurality of subfields is longer than a width of the sustain pulse in a second subfield, the subfield load ratio of the second subfield being greater than the subfield load ratio of the first subfield.

5. The plasma display as claimed in claim 1, wherein the plurality of discharge cells includes a plurality of first discharge cells and a plurality of second discharge cells, and the controller is configured to divide the address period into first and second address periods with respect to the plurality of first and second discharge cells, establish one sustain period to be a first sustain period between the first and second address periods, establish another sustain period to be a second sustain period after the second address period, and establish the first sustain period in proportion to the subfield load ratio.

6. The plasma display as claimed in claim 1, wherein the controller comprises a subfield load ratio calculating unit configured to calculate the subfield load ratio from a ratio of a number of all the discharge cells and a number of light emitting cells in the corresponding subfield.

7. The plasma display as claimed in claim 1, wherein at least one subfield among the plurality of subfields further comprises a reset period for initializing at least one discharge cell among the plurality of discharge cells, the controller being configured to establish the address period in proportion to the subfield load ratio and at least one of the sustain period and the reset period according to the established address period.

8. The plasma display as claimed in claim 1, wherein the controller is configured to establish the address period in proportion to the subfield load ratio;
and establish the sustain period according to the established address period

9. A driving method of a plasma display including a plurality of discharge cells and one frame divided into a plurality of subfields, each subfield including an address period and a sustain period, the driving method comprising:
calculating a subfield load ratio of each subfield from a video signal input during the frame;
establishing at least one of the address period and the sustain period in respective subfields according to the calculated subfield load ratio;
selecting light emitting cells from among the plurality of discharge cells during the established address period; and
sustain-discharging the light emitting cells a number of times corresponding to a weight value of the corresponding subfield during the established sustain period.

10. The driving method as claimed in claim 9, wherein the subfield load ratio is calculated from a ratio of a number of all the discharge cells and a number of light emitting cells in the corresponding subfield.

11. The driving method as claimed in claim 9, wherein establishing the address period and the sustain period comprises:
establishing the address period in proportion to the subfield load ratio; and
establishing the sustain period according to the established address period.

12. The driving method as claimed in claim 9, wherein at least one subfield among the plurality of subfields includes a reset period for initializing at least one discharge cell among the plurality of discharge cells, and establishing the address period includes establishing the address period in proportion to the subfield load ratio, the driving method further comprises establishing at least one of the sustain period and the reset period according to the established address period.

13. The driving method as claimed in claim 9, wherein selecting light emitting cells includes applying an address pulse to the light emitting cells, wherein a width of the address pulse in a first subfield among the plurality of subfields is shorter than a width of the address pulse in a second subfield, the subfield load ratio of the second subfield being greater than the subfield load ratio of the first subfield.

14. The driving method as claimed in claim 9, wherein sustain-discharging the light emitting cells includes applying a sustain pulse to the light emitting cells, wherein a width of the sustain pulse in a first subfield among the plurality of subfields is longer than a width of the sustain pulse in a second subfield the subfield load ratio of the second subfield being greater than the subfield load ratio of the first subfield.

15. A method for driving a plasma display including a plurality of discharge cells while dividing one frame into a plurality of subfields, the method comprising:
calculating a subfield load ratio of each subfield from a video signal input during the frame;
determining a width of an address pulse in each subfield according to the subfield load ratio; and
applying the address pulse of the determined width to light emitting cells among the plurality of discharge cells during an address period of each subfield.

16. The method as claimed in claim 15, wherein determining of the width comprises establishing the width of the address pulse in a first subfield among the plurality of subfields to be shorter than that of the address pulse in a second subfield having the subfield load ratio that is greater than that of the first subfield.

17. The method as claimed in claim 15, further comprising:
determining a width of a sustain pulse in each subfield according to the subfield load ratio; and
applying the sustain pulse of the determined width to the plurality of discharge cells during a sustain period of each subfield.

18. The method as claimed in claim 17, wherein determining of the width of the sustain pulse comprises establishing the width of the sustain pulse in a first subfield among the plurality of subfields to be longer than that of the sustain pulse in a second subfield having the subfield load ratio that is greater than that of the first subfield.

19. The method as claimed in claim 15, wherein the subfield load ratio is calculated from a ratio of a number of all the discharge cells and a number of light emitting cells in the corresponding subfield.

20. The method as claimed in claim 15, wherein at least one subfield among the plurality of subfields includes a reset period for initializing at least one discharge cell among the plurality of discharge cells, the method further comprising determining a width of a pulse in at least one of the sustain period and the reset period according to the width of the address pulse.
